(19) United States
(12) Patent Application Publication
(10) Pub. No.: US 2010/0257765 A1
(43) Pub. Date: Oct. 14, 2010

(54) SHADOWS OF LIFE LIGHT BOX

(76) Inventor: Renee C. Rogers, Topeka, KS (US)

Correspondence Address: Renee C. Rogers, 6224 SW 48th Lane, Topeka, KS, 66610, US

(21) Appl. No.: 12/422,040

(22) Filed: Apr. 10, 2009

(51) Int. Cl. G09F 13/04

(52) U.S. Cl. 40/564

(57) ABSTRACT

The “Shadows of Light . . . Light Box” consists of a custom built wooden decorative shadow box. Inside the enclosed box are glass panes methodically situated, creating visual layers of inspirational depictions. The unique construction of the box provides a constant visual message designed to inspire ones personal fulfillment. A protective first glass pane, second pane with custom depiction, a depiction affixed to the back of a mottled section of glass creates a “one of one”, unique, visually multidimensional message. When illuminated, the multi faceted depictions create an illusion of gazing into a universe of stars. These boxes may be used in an individuals home or business for the purpose of décor, or for advertisement of product at retail. The message depictions are wide ranging, consisting of, but not limited to biblical verses, sports memorabilia, personalized inspirational messages, retail or commercial advertisements, awards, in memory of remembrances.

### FIELD OF THE INVENTION

The invention pertains generally to a uniquely conceived container to accommodate communication transmitted by written words. More specifically, the invention relates to a container with an illuminated electrical source in association with a series of transparent solid substrates with opaque depictions. The container includes a unique receptacle containing a plurality of transparent glass, stained glass, or similar substrates methodically placed to create depth with unique illumination of the communication.

### BACKGROUND OF THE INVENTION

Many forms of communication substrates are available including illuminated or non-illuminated. The one common feature of all substrates is they are one dimensional.

The equipment needed for displaying the communication varies according to the procedure for which the communication is intended. For example, posters and decals are affixed to windows and doors while lighted signs are affixed to walls.

This operation has the obvious disadvantage of innefficiency of delivering a message. There is a definite need in the art of communication for overcoming the above disadvantages of one dimensional messages with a unique new presentation that demands attention. It is toward fulfillment of this need that the present invention is directed.

### SUMMARY OF THE INVENTION

A unique container of materials for communicating a message via depictions affixed to transparent or obscure substrates, means for uniquely projecting the message, methodical placement of all of the components and packaging means for all of the components.

### DESCRIPTION OF THE FIGURES

FIG. 1A is a block diagram that illustrates a front view of an illuminated light box.

FIG. 1B is a block diagram that illustrates a front view of the non-illuminated light box.

FIG. 2 is a block diagram that illustrates an open-ended side view of the light box.

FIG. 3A is a block diagram that illustrates a back support for the light box.

FIG. 3B is a block diagram that illustrates a back support & illumination source for the light box.

### DESCRIPTION

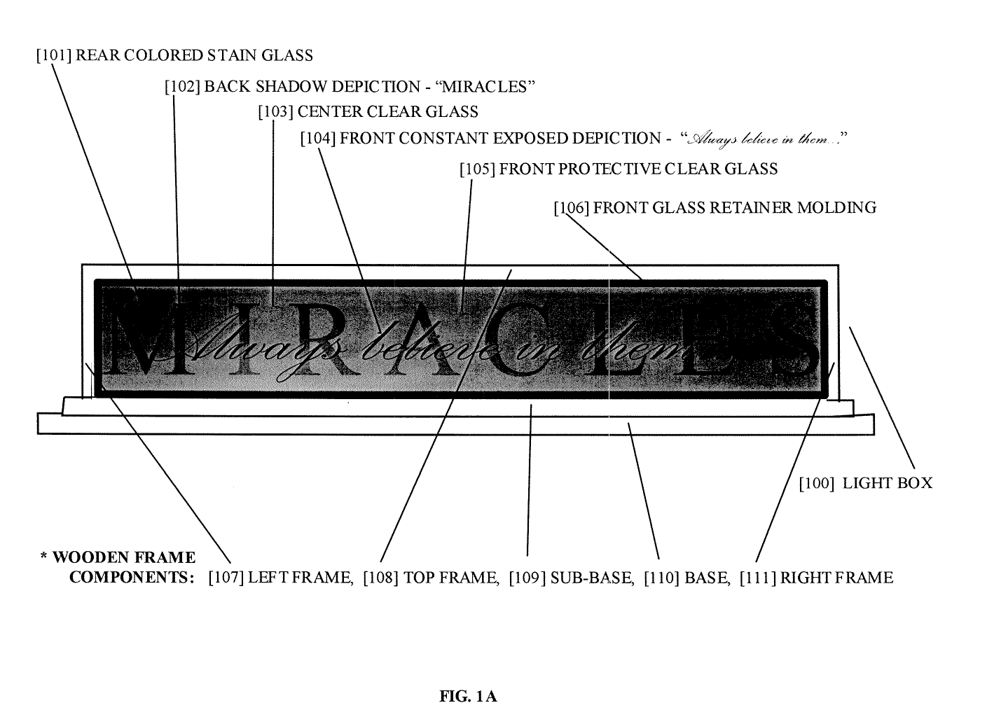

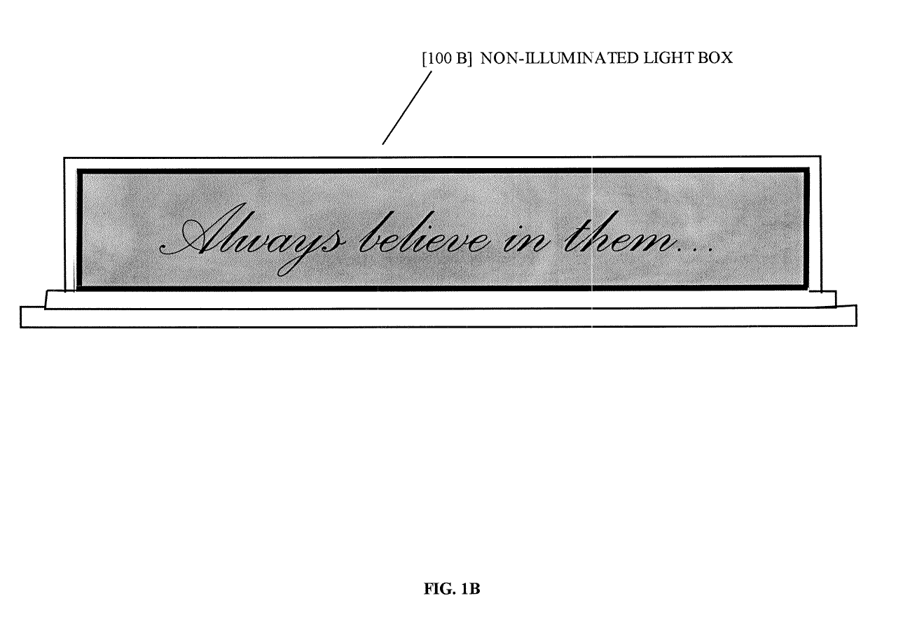

FIG. 1A is a block diagram that illustrates a front view of light box 100. Light box 100 comprises rear glass 101, back shadow depiction 102, center glass 103, front exposed depiction 104, front glass 105, front glass retainer molding 106, left frame 107, top frame 108, sub-base 109, base 110, and right frame 111.

Rear glass 101 comprises colored stained glass, transparent glass, tinted glass, or some other form of opaque or partially opaque material. Back shadow depiction 102 comprises an opaque image or text affixed to rear glass 101 using an adhesive, wherein the adhesive comprises any bonding agent including glue, paste, tape, epoxy and any other bonding agent which is not yet known to man. Back shadow depiction 102 may be created manually or by using a custom die-cut machine to cut an image or text into an opaque material. In one example, back shadow depiction 102 comprises the text “MIRACLES”.

Center glass 103 comprises transparent glass or some other form of transparent or partially transparent material. Front exposed depiction 104 comprises an opaque or partially opaque image or text affixed to center glass 103 using an adhesive, wherein the adhesive comprises any bonding agent including glue, paste, tape, epoxy and any other bonding agent which is not yet known to man. Front exposed depiction 104 may be created manually or by using a custom die-cut machine to cut an image or text into an opaque or partially opaque material. In one example, front exposed depiction 104 comprises the text “Always believe in them . . . ”.

Front exposed depiction 104 is visible at all times whether light box 100 is on (illuminated) or off (not illuminated). Back shadow depiction 102 is only visible when light box 100 is on, or illuminated, as illustrated in FIG. 1A. However, back shadow depiction 102 is not visible when light box 100 is off, or not illuminated, as illustrated in FIG. 1B.

Returning to FIG. 1A, front glass 105 comprises transparent glass or some other form of transparent or partially transparent material. Front glass retainer molding 106, left frame 107, top frame 108, sub-base 109, base 110, and right frame 111 comprise wood, plastic, metal, or any other material suitable for the construction of light box 100 including any material which is currently available and any other material which is not yet known to man.

In one example, front glass retainer molding 106 further comprises at least four pieces of fluted decorative wood which is affixed to the front of left frame 107, top frame 108, right frame 111, and the top of sub-base 109. Sub-base 109 is affixed to base 110, left frame 107, and right frame 111; left frame 107 is affixed to top frame 108; right frame 111 is affixed to top frame 108 such that the components for a rectangle seated on top of sub-base 109 which is seated on base 110, wherein sub-base 109 has at least the dimensions of top frame 108 and wherein the components are fastened together by nails and adhesive material.

Rear glass 101, center glass 103, and front glass 105 fit vertically inside the rectangle formed by left frame 107, top frame 108, right frame 111, and sub-base 109. Although clear and stained glass is used in some examples for rear glass 101, center glass 103, and front glass 105, any solid translucent or semi-opaque substrates suitable for affixing depictions described herein can be substituted, including any material which is currently available, such as Plexiglas, plastics, or any other material which is not yet known to man.

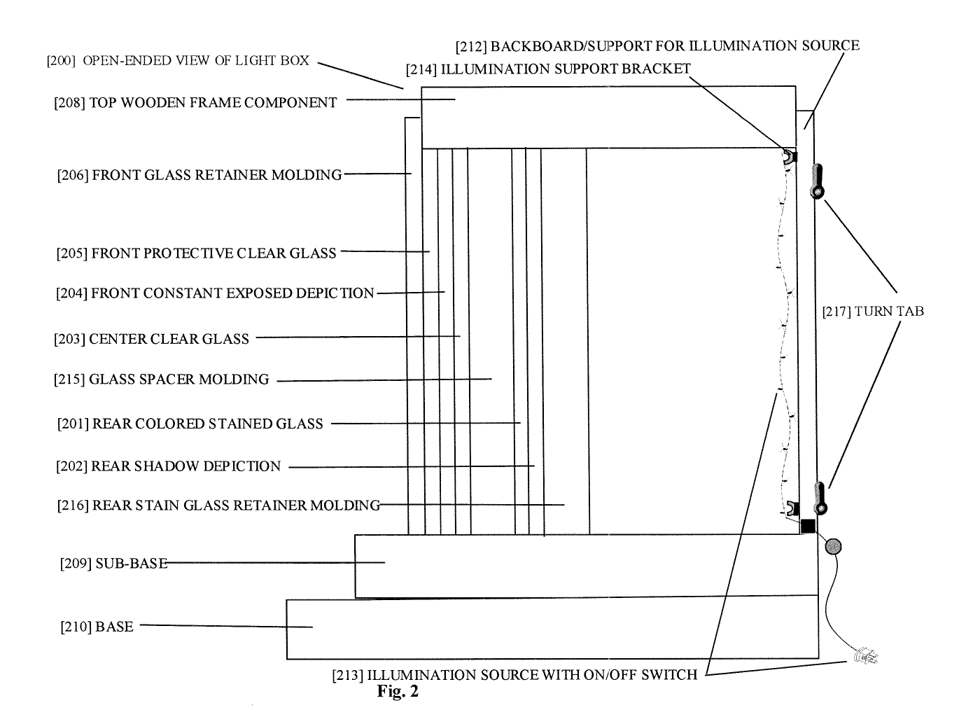

FIG. 2 is a block diagram that illustrates an open-ended side view of light box 200. Light box 200 comprises rear glass 201, back shadow depiction 202, center glass 203, front exposed depiction 204, front glass 205, front glass retainer molding 206, top frame 208, sub-base 209, base 210, backboard 212, illumination source 213, illumination support brackets 214, glass spacer molding 215, rear glass retainer molding 216, and turn tabs 217.

Rear glass 201 comprises colored stained glass. Back shadow depiction 202 comprises an opaque image or text affixed to rear glass 201. In one example, back shadow depiction 202 comprises the text “FAMILY”. Center glass 203 comprises transparent glass or colorless glass. Front exposed depiction 204 comprises an opaque image or text affixed to center glass 203. In one example, front exposed depiction 204 comprises the text “The essence of life . . . ”.

Front exposed depiction 204 is visible at all times whether light box 200 is on (illuminated) or off (not illuminated). Back shadow depiction 202 is only visible when light box 200 is on, or illuminated. However, back shadow depiction 202 is not visible when light box 200 is off, or not illuminated.

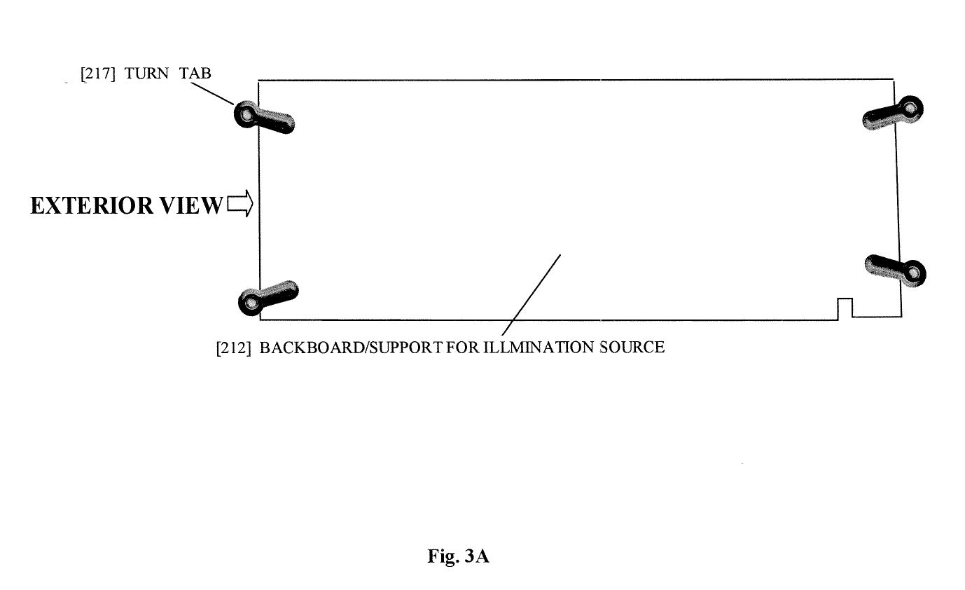

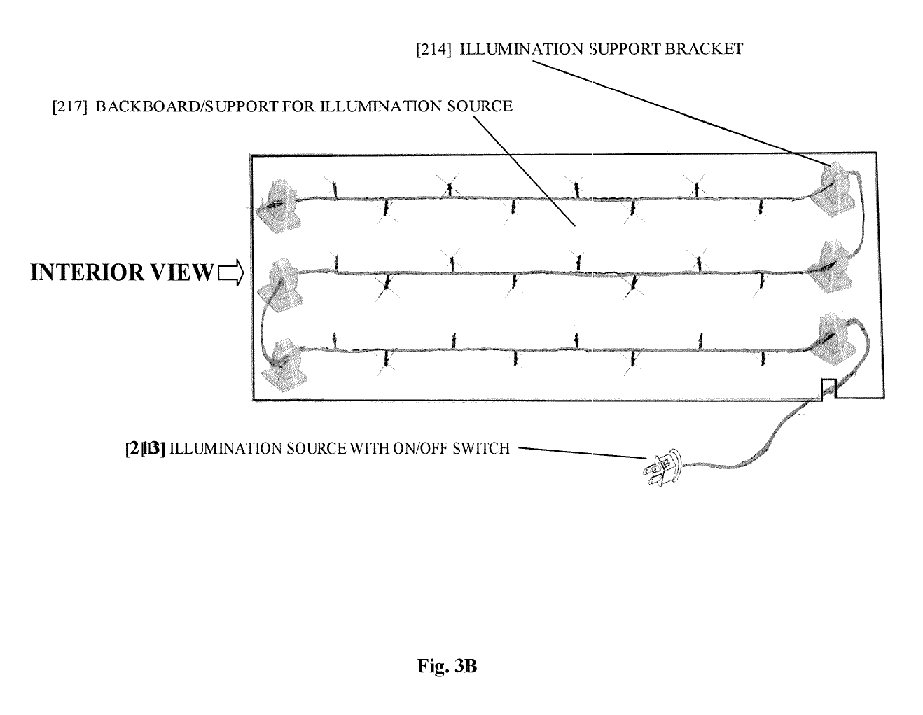

Front glass 205 comprises transparent or colorless glass. Front glass retainer molding 206, top frame 208, sub-base 209, base 210, and backboard 212, illumination support brackets 214, glass spacer molding 215, rear glass retainer molding 216, and turn tabs 217 comprise wood, plastic, metal or any other material suitable for the construction of light box 200 including any material which is currently available and any other material which is not yet known to man. In one example, front glass retainer molding 206, top frame 208, sub-base 209, base 210, illumination support brackets 214, glass spacer molding 215, and rear glass retainer molding 216 comprise wood and are fastened together by nails and adhesive material. In one example, backboard 212 is secured to the back of light box 200 using turn tabs 217, wherein backboard 212 is wood, turn tabs 217 are metal, and turn tabs 217 are secured to left frame 107, right frame 111, and top frame 208 using metal screws. Turn tabs 217 allow for the opening and closing of light box 200 by securing or removing backboard 212. FIG. 3A illustrates backboard 212 and turn tabs 217 from a rear view.

Returning to FIG. 2, illumination source 213 comprises a series of one or more lights connected to a power source, wherein the power source could be a battery or an electrical connector. Illumination source 213 may also comprise an on/off switch. When illumination source 213 is attached to a battery, connected to a source of electricity, or the on/off switch is in the “on” position, then the series of one or more lights are lighted. Illumination source 213 is affixed to backboard 212 using illumination support brackets 214. In one example, backboard 212 has a small opening for the lead of illumination source 213 to protrude from the inner cavity of light box 200. In one example, illumination source 213 comprises a 35-50 count miniature portable luminescent strand strategically strung throughout light box 200 and affixed to each illumination support bracket 214. FIG. 3B illustrates backboard 212, illumination source 213, and illumination support bracket 214 from an interior view. Illumination source 213 may comprise any type of illumination source such as, but not limited to, fluorescent light, halogen light, micro lights, mini lights, LED light, candle light, sunlight, or any other such lighting that can be used as an illumination source or any other illumination source that is not yet known to man.

There are eight components methodically layered inside the cavity which create the depictions and depth. Beginning from front to back, directly behind front glass retainer molding 206, the components are placed in the following order: front glass 205, front exposed depiction 204, center glass 203, glass spacer molding 215, rear glass 201, back shadow depiction 202, rear glass retainer molding 216, and illumination source 213.

All depictions and all glass are methodically positioned in such a manor that depth is created, with depictions on glass that create visual multidimensional messages which are conveyed in tiers as you look into the illuminated light box. The illumination source creates an illusion of gazing into a universe full of stars.

Front exposed depiction 204 requires no light from illumination source 213 in order for it to be visible. Rear shadow depiction is only visible when illumination source 213 is receiving power, is turned on, or is otherwise lighted. You do not get the effect of the visual multidimensional tiers with illumination source 213 turned off, not receiving power, or otherwise not lighted.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A multidimensional communication device for delivering a visual message, the device comprising:
a six-sided box, wherein a left side, right side, top, and bottom comprise a solid, opaque material and are permanently fastened together and wherein a front comprises a first pane and wherein a back panel comprises a solid, opaque material and is temporarily fastened to at least the left side and the right side;
a second pane comprising text or images and positioned behind the first pane and in front of the back panel, wherein the text or images of the second pane are always visible;
a first spacer affixed to the six-sided box and positioned behind the second pane and in front of the back panel;
a third pane comprising text or images and positioned behind the first spacer and in front of the back panel, wherein the text or images of the third pane are not always visible;
a second spacer affixed to the six-sided box and positioned behind the third pane and in front of the back panel; and
an illumination source affixed to the back panel with a support bracket.

2. The device of claim 1 wherein the left side, right side, top, bottom, and back panel of the six-sided, the first spacer, and the second spacer are wood.

3. The device of claim 1 wherein the first pane is transparent glass.

4. The device of claim 1 wherein the second pane is transparent glass inscribed with the text “Always believe in them . . . ”.

5. The device of claim 1 wherein the third pane is stained glass inscribed with the text “MIRACLES”.

6. The device of claim 1 wherein the illumination source is a 35-50 count miniature portable luminescent strand with a power source and an on/off switch.

7. The device of claim 6 wherein the text or images of the third pane are only visible when the illumination source is receiving power or is switched on.

8. The device of claim 1 wherein the back panel is temporarily fastened to at least the left side and the right side with two metal turn tabs.

9. The device of claim 6 wherein the text or images of the second pane and the text or images of the third pane are both visible when the illumination source is receiving power or is switched on.

10. The device of claim 6 wherein the text or images of the second pane are visible when the device is not receiving power or is switched off and the text or images of the third pane are not visible when the device is not receiving power or is switched off.

11. The device of claim 1 wherein the six-sided box is affixed to a base that is at least as large as the bottom.
